(19) United States
(12) Patent Application Publication
(10) Pub. No.: US 2006/0241949 A1
(43) Pub. Date: Oct. 26, 2006

(54) Imaging process for financial data

(76) Inventors: David Michael Tobias, New South Wales (AU); Graeme Edward Neil Macdonald, New South Wales (AU)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 10/550,656

(22) PCT Filed: Mar. 26, 2004
(86) PCT No.: PCT/AU04/00375

§ 371 Date: Jun. 7, 2006

(30) Foreign Application Priority Data
Mar. 28, 2003 (AU) 2003901503

(51) Int. Cl. G06Q 99/00; G06Q 40/00

(52) U.S. Cl. 705/1; 705/35

(57) ABSTRACT

An imaging system, including a visualisation module for generating image display data representing at least one three-dimensional object at the origin of a spatial coordinate system, the dimensions and colour of each object being determined on the basis of financial data for a corresponding financial product. The colour of each object represents a measure of risk for the corresponding financial product, which can include a stock or a managed fund. The dimensions of each object representing a stock correspond to price to earnings ratio, dividend yield, and growth in earnings per share for the corresponding stock. The dimensions of each object representing a fund correspond to measures of financial return over respective periods of time for the corresponding fund. However, a user of the system can associate different financial parameters or measures with the object dimensions and colour as desired.

### FIELD OF THE INVENTION

The present invention relates to an imaging process, and in particular to a system and process for generating image display data to represent financial data for a financial product, such as a managed or mutual fund, or shares or stocks in a company.

### BACKGROUND

Financial data can be difficult to comprehend, particularly for non-experts. Consequently, many people rely on investment advisors and other consultants to provide advice in relation to financial products such as shares or stocks and managed funds or mutual funds. Yet consultants can be expensive and introduce a further layer of difficulty for lay persons.

To evaluate different investment options, it is often helpful if complex financial data can be graphically represented to enable important characteristics and trends to be easily and rapidly comprehended by visual inspection. This can be particularly important when two or more financial products are to be compared, where each product is characterised by various financial data parameters. For example, owners of and investors in financial products such as shares or stocks, bonds, mutual and other managed funds need to make judgements based on the past, current and prospective values of these assets in order to make buy, hold, and/or sell decisions. However, currently available systems and processes for graphically representing financial data for such products are overly complex for non-expert users. For example, multiple stock or share parameters are typically viewed as text, tables and/or two dimensional graphs or charts that are often difficult to comprehend, and presume a high level of expert knowledge. Consequently, assessing the quality of selected stocks is particularly difficult for non-experts, and this affects the quality of an individual's investment decisions.

It is desired, therefore, to provide image display data, a graphical user interface, a computer program, an image data process, and an imaging system and process for generating image display data using financial data that alleviate one or more difficulties of the prior art, or at least provide a useful alternative. In particular it is desired to provide image display data, a graphical user interface, a computer program, an image data process, and an imaging process and system that allow a lay person to readily assess fundamental characteristics of a financial product without having to possess expertise in financial analysis.

### SUMMARY OF THE INVENTION

In accordance with the present invention, there is provided an imaging process, including generating image display data representing a three-dimensional object at the origin of a spatial coordinate system, the dimensions of said object being determined on the basis of financial data for a financial product.

The present invention also provides an imaging process, including generating image display data representing a three-dimensional object, the dimensions and colour of said object being determined on the basis of financial data for a financial product.

The present invention also provides an imaging process, including generating image display data representing a three-dimensional object, the dimensions of said object being determined on the basis of respective measures of price, income, and growth of a stock.

The present invention also provides an imaging process, including generating image display data representing a three-dimensional object, the dimensions of said object being determined on the basis of performance data for a fund over respective time periods.

The present invention also provides an imaging process, including generating image display data representing a three-dimensional object at the origin of a spatial coordinate system, the dimensions and colour of said object being determined on the basis of financial data for a financial product.

The present invention also provides an image data process, executed by a computing device, including generating image data for displaying a three-dimensional object at the origin of a spatial coordinate system, the dimensions of said object corresponding to financial data for a financial product.

The present invention also provides a system having components for executing the steps of any one of the above processes.

The present invention also provides a computer readable storage medium having stored thereon program code for executing the steps of any one of the above processes.

The present invention also provides a graphical user interface, including a display of a three-dimensional object at the origin of a spatial coordinate system, the dimensions of said object being determined on the basis of financial data for a financial product.

The present invention also provides a computer program, stored on computer readable media, for generating image display data representing a three-dimensional object at the origin of a spatial coordinate system, the dimensions of said object being determined on the basis of financial data for a financial product.

The present invention also provides image display data, including image coordinate data representing a three-dimensional object at the origin of a spatial coordinate system, the dimensions of said object corresponding to financial data for a financial product.

The present invention also provides an imaging system, including a visualisation module for generating image display data representing at least one three-dimensional object at the origin of a spatial coordinate system, the dimensions of each object being determined on the basis of financial data for a corresponding financial product.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of an imaging system connected to remote computer systems via a communications network;

FIG. 2 is a flow diagram of an imaging process executed by the imaging system;

FIG. 3 is a flow diagram of a financial product selection process executed by the imaging system; and

FIGS. 4 to 17 are screenshots generated by the imaging system.

### DETAILED DESCRIPTION OF THE PREFERRED EMBODIMENT

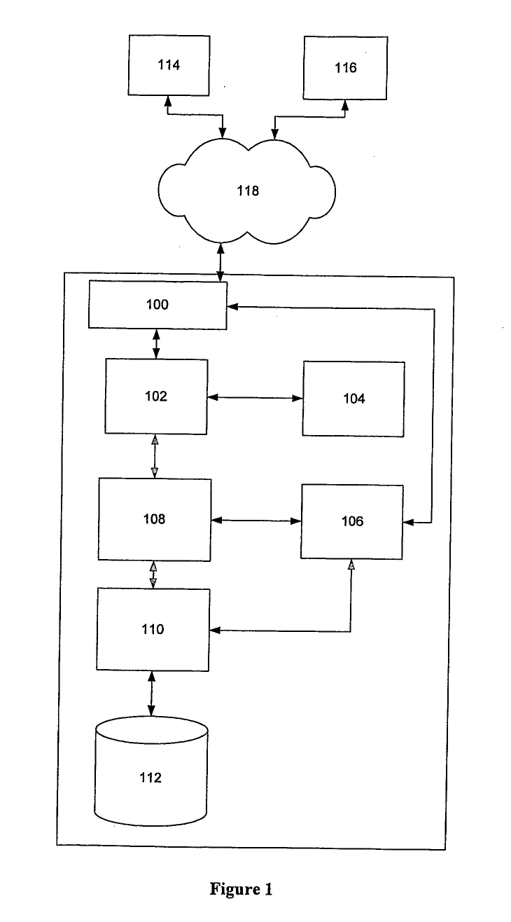

An imaging system, as shown in FIG. 1, executes an imaging process that generates a graphical user interface or image display data for visualising financial data associated with one or more financial products, such as shares, also known as stocks, and managed funds, also known as mutual funds. The imaging system includes a network interface 100 and imaging modules 102 to 112, comprising a web server 102, visualisation scripts 104, a transaction engine 106, a scripting language module 108, a database interface module 110, and a database 112. The imaging system constitutes an evaluation tool and can be accessed as part of, or even integrally provides, a network site for a broker or broking institution, such as Goldman Sachs (http://www.gs.com) or Charles Schwab (http://www.schwab.com). As shown in FIG. 1, the imaging system can be connected to remote systems, such as a client system 114 and a stock exchange system 116, via the network interface 100 and a communications network 118, such as the Internet.

In the described embodiment, the imaging system is a computer system, such as an Intel™-based high-performance server executing a Linux™ operating system and the network interface 100 is a network interface connector such as a 3Com Etherlink 3 Vortex Ethercard. The web server module 102 is a web server, such as Apache, available at http://www.apache.org, the scripting language module 108 is a scripting language module such as PHP, available at http://www.php.net, and the database interface module 110 is a structured query language (SQL) database module such as MySQL, available at http://www.mysql.com. The transaction engine 106 allows a user of the imaging system to perform buy and/or sell operations for financial products and communicates with the stock exchange system 116 to periodically obtain financial data on the financial products. The transaction engine 106 is based on an online broking engine, as used by online broking sites, such as http://www.etrade.com. The imaging process is implemented by software modules, being the imaging modules 102 to 112, including text-based and binary program code or instructions stored in non-volatile storage memory (e.g., magnetic disk storage) of the server. In particular, the visualisation scripts 104 include HTML, JavaScript, and PHP scripts that control the imaging process. The scripts 104 are interpreted by the web server 102 and PHP module 108. The imaging process also uses data held in the database 112, which is queried by SQL queries included in or generated from the visualisation scripts 104. However, it will be apparent to those skilled in the art that at least parts of the imaging process executed by the imaging system can be alternatively implemented by dedicated hardware components such as application-specific integrated circuits (ASICs). Another alternative is that all or part of the software code for executing the imaging process can be stored locally on a user's client system 114. The client system may then rely on data stored locally and/or accessed via the network 118. The client system 114 can be any computing device that can generate an image display, including a personal computer, a mobile telephone or a personal data assistant (PDA).

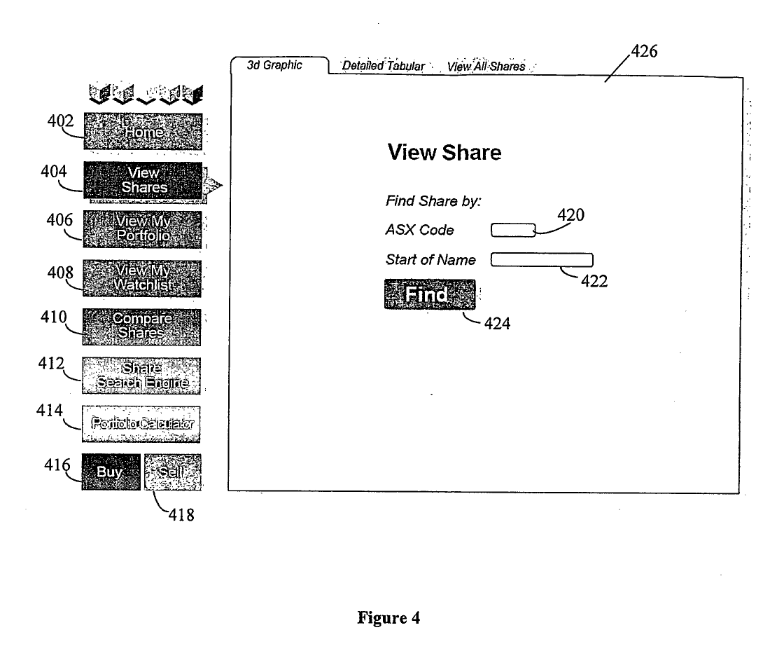

The imaging system can be accessed by remote users via the Internet 118. For example, a user of the client system 114, being a personal computer system equipped with web browser software such as Microsoft Internet Explorer, can access the imaging system in a standard manner by providing to the web browser a universal resource indicator (URI) assigned to the imaging system. This causes the web browser to send a request to the imaging system, using the hypertext transfer protocol (HTTP). When the web server 102 receives this request, it retrieves one of the visualisation scripts 104, including hypertext markup language (HTML) elements, scripting language (PHP) code, or JavaScript code, processes any scripting language or server-side JavaScript code, and returns the resulting image display data, including HTML elements or client-side JavaScript code, to the web browser of the client system 114. This causes the web browser to generate and display a graphical user interface including an imaging page, such as that shown in FIG. 4, that allows the user to interact with the imaging system by selecting active controls including the main buttons 402 to 418. For example, the Find Share panel 426 shown in FIG. 4 is generated in response to selection of a View Shares button 404 of the main buttons 402 to 418.

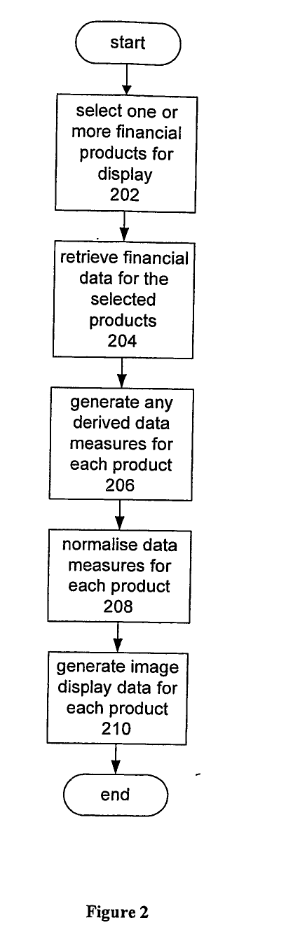

The imaging system displays data for a financial product such as a stock by executing the imaging process, as shown in FIG. 2. The process begins at step 202 by determining which financial product or products are to be displayed. For example, the Find Share panel 426 described above includes a first text box 420 for entering the stock exchange code of a stock, and a second text box 422 for entering a stock name or part thereof. After entering the appropriate information into one of these text boxes 420, 422, a Find button 424 is selected to find a stock matching the information provided. When the user selects the Find button 424, the web browser 102 submits the entered information to the web server 102 using an HTTP request that also identifies a stock search script of the visualisation scripts 104, which is used to perform the stock search. The script performs the search by matching the information provided by the user with stock codes or stock names stored in the database 112 via an SQL query.

Having identified at least one stock for display, the financial data to be used to generate the display for that stock is retrieved at step 204 by querying the database 112. The database 112 stores all available financial data for each financial product, including parameters such as buy and sell prices, trading volumes, earnings, dividends, growth, volatility, and other variables and measures used to characterise stocks. The database 112 is updated when live financial data is received from remote financial systems (not shown), including live trading data, dividends, and earnings figures and forecasts. The database 112 stores past, current, and future earnings and dividends forecasts.

Any of the stored financial parameters or measures can be displayed or used to generate derived values for display, if desired. In the latter case, any derived data measures to be displayed for each selected stock are generated at step 206. However, once any derived values have been determined, they can be stored in the database 112 if desired. By default, the following four financial measures are used to represent a stock: price, using the measure of the price to earnings ratio (P/E), income, using the measure of dividend yield, growth, using the measure of earnings per share growth, and risk of the stock, using the standard beta value. However, the user can change any or all of these to visualise any desired combination of financial parameters or measures.

At step 208, the data measures retrieved from the database 112 at step 204 or generated at step 206 are normalised with respect to the corresponding measures for an aggregate or grouping of stocks using data stored in the database 112, if available. In the case of a stock, the default aggregate represents the market, but the user can alternatively select other aggregates for normalisation purposes, such as stocks in the same market sector, or stocks in the user's portfolio, for example. However, as with derived data measures, the resulting normalised data can alternatively be stored in the database 112 to avoid needless repetition of the normalisation step 208. However, if a new data measure is generated for the first time at step 206, then reference values for the new data measure representing the selected aggregate of financial products (e.g., the market) are determined, as described below, and the resulting values used to normalise the values for each selected stock at step 208.

At step 210, image display data is generated for the stock, based on the normalised data measures. This includes generating coordinate data representing the normalised values for each selected parameter assigned to the dimensions of the object (by default, price to earnings ratio (P/E), dividend yield, and earnings per share growth) as projected onto the isometric representation of the object. Colour data is also generated, representing a colour assigned to the normalised value for the selected parameter assigned to object colour, preferably modified by different shadings of the colour applied to each visible surface of the object. The use of different shadings improves the appearance of the object.

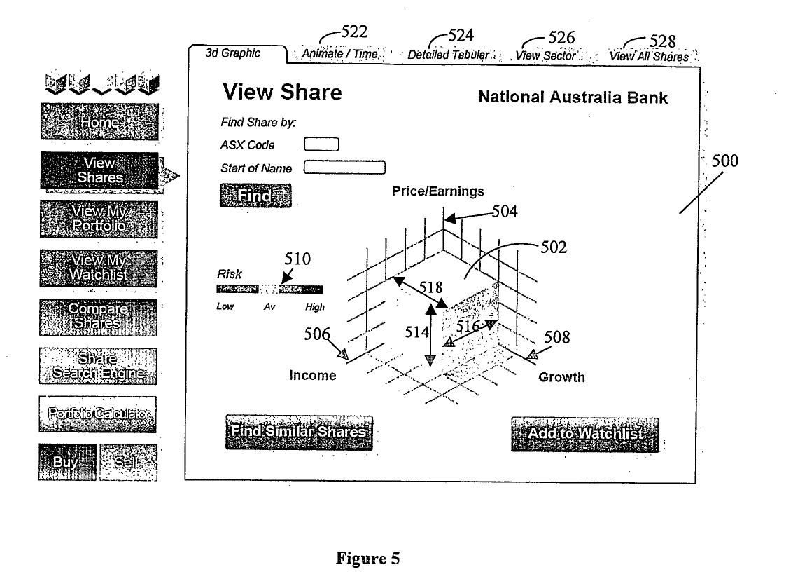

The image display data is then sent from the web server 102 to the web browser of the client system 114 for display to the user. As shown in FIG. 5, the result is a View Share panel 500 displaying a three-dimensional object 502 representing the selected stock. The object 502 is a rectangular parallelepiped, and is displayed at the origin of a three dimensional co-ordinate system having respective axes 504 to 508. Although the object 502 is preferably solid, as shown, it can alternatively be represented as an open frame structure. The dimensions of the object 502 along each of the three axes 504 to 508 represent respective values for that stock, normalised to the market. Thus the dimension 514 or height of the object 502 along the vertical axis 504 represents the price to earnings ratio (P/E) of the stock relative to the market. The price to earnings ratio is derived by dividing the current share price by the historic, current or prospective earnings per share of the company.

The dimension 516 or width of the object 502 along the left-hand horizontal axis 506 represents the relative income of the stock, using the dividend yield of the stock relative to the average of the market. Dividend yield is a measure of the cash return on the investment in a stock, and is a better measure of income than the actual dividends alone. Dividend yield is determined by dividing the historic, current, or prospective dividend by the current share price, and is usually expressed as a percentage. A higher dividend yield shows a high cash return on investment in the form of income to shareholders, while a low dividend yield indicates a low cash return.

The dimension 518 or length of the object 502 along the right hand horizontal axis 508 represents the relative growth of the stock, using the measure of earnings per share (EPS) growth of the stock relative to the average of the market. EPS growth is a better measure of growth than earnings growth alone. Earnings per share is determined by dividing the after tax profit of the company by the number of shares issued. EPS growth is then determined by dividing the estimated next year EPS by the current EPS. A high EPS growth indicates that analysts are predicting high future profit growth, while a low EPS growth indicates that lower future profit growth is anticipated.

The colour of the object 502 represents the risk of the share relative to the market. Colour is determined from the standard beta value for the stock. However, it will be apparent that other measures of risk can alternatively be used, such as debt to equity ratio, for example. By definition, the market has a beta value of 1, and a beta of 1.2 implies that the stock will move 20% higher or lower when the market rises or falls, respectively. Conversely, a beta value of 0.5 implies that the stock's price change will be only half the market's rise or fall. The use of colour allows the user to identify the risk of the share at a glance by simply observing the colour. The level of risk corresponding to the object's colour is indicated by a risk indication bar 510. A red colour indicates that the share price will move considerably more than the market average change, whilst a blue colour indicates a relatively low risk of share price movements.

To further simplify the interpretation of the displayed data, the dimensions and colour of a displayed object can be quantized or rounded to the nearest of a fixed number of allowed values if desired. For example, the dimensions of the object 502 shown in FIG. 5 can have one of five possible values and the object 502 can have one of five possible colours. Accordingly, the three axes 504 to 508 are displayed with four grid lines to clearly identify the corresponding value as the edges of the object 502 are aligned with one of these grid lines or the boundary of the grid. No grid line is shown corresponding to the maximum (5^{th}) quantized value to improve the appearance of the display.

When the dimensions and/or the colour of a displayed object are quantised and represent normalised values relative to an aggregate of financial products of the same type (e.g., in the case of stocks, the default aggregate is the market), each quantised value is determined by determining reference values defining ranges for the corresponding measure from data stored in the database 112. For example, as shown in FIG. 5, dimension 514 or height of the object 502 along the vertical axis 504 representing the price to earnings ratio (P/E) of the stock relative to the market, the five quintiles of the vertical axis 504 can be assigned to respective price (e.g., P/E value) ranges of <8, 8-12, 12-16, 16-25, and >25. These ranges are defined by the four reference values 8, 12, 16, and 25 for the parameter price to earnings ratio in this example, and can change over time. Reference values can be defined by the user or determined automatically from the stored data. In the latter case, the user can control how the reference values are automatically determined. For example, the user can fix the width of each range (i.e., the difference between successive reference values) and allow the system to determine the absolute value of each reference value so that, for example, the central (3^{rd}) range is centred on an average value for the measure of the entire market. Alternatively, the system can automatically generate reference values based on a statistical or other distribution of stocks across the market.

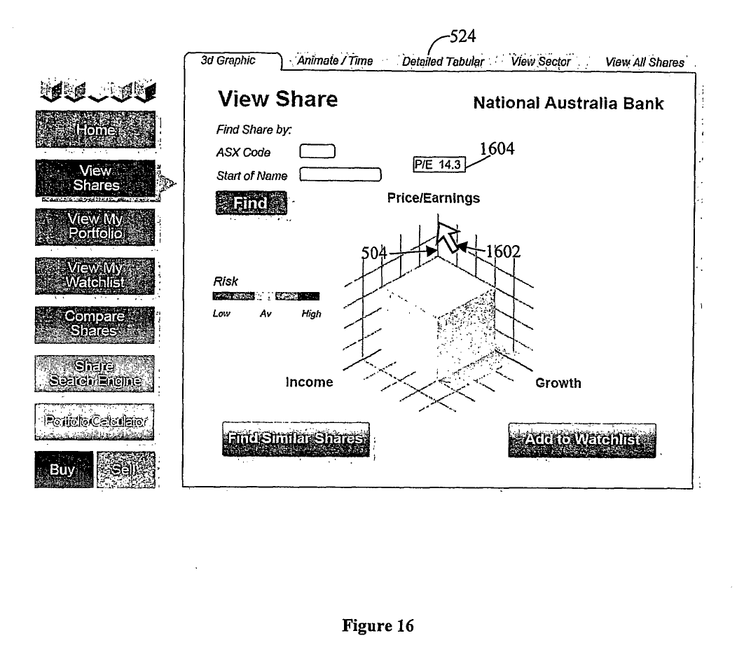

Actual un-normalised numeric values for the financial measures corresponding to the three axes 504 to 508 and the object colour for a selected stock can be displayed by moving a pointing device such as a mouse pointer over the corresponding axis or the object, respectively. For example, as shown in FIG. 16, when a mouse pointer 1602 is moved over the P/E axis 504, a pop-up window 1604 is displayed, indicating the corresponding P/E ratio of 14.3 for the selected stock. The displayed value can be the exact value for the stock or rounded to the nearest grid line value, as described above.

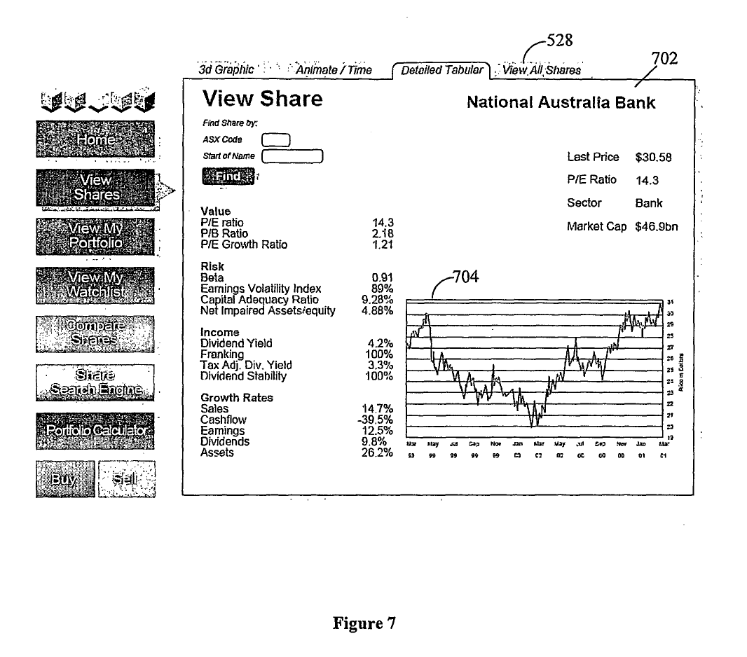

Detailed tabulated data for the stock can be viewed by selecting a detailed tabular view tab 524. This results in a display of a detailed view panel 702, as shown in FIG. 7, providing detailed tabular financial information for the share, and a graph 704 of the stock's historical price movements, as shown here, or of other historical data about the stock.

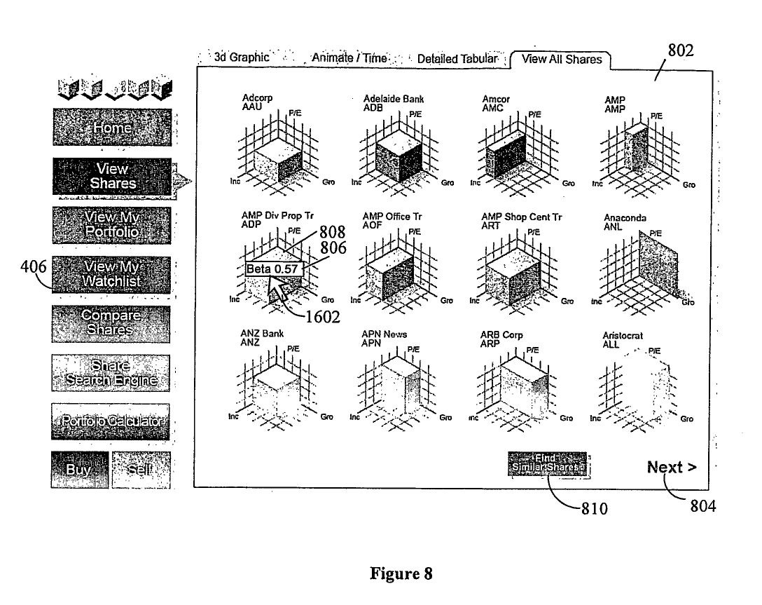

All shares on the market can be viewed by selecting a View All Shares Tab 528. This results in the display of a View All Shares Panel 802, as shown in FIG. 8. The View All Shares panel 802 displays twelve stocks at a time, and provides a Next button 804 and, on subsequent View All Shares panels, a Previous button (not displayed on the first displayed View All Shares Panel 802) that allow the user to navigate through all of the View All Shares panels to view all market stocks in groups of twelve. Alternatively, other methods of navigation can be employed to allow the user to search for selected pages of stocks, such as using an alphabetical index. As will be apparent from FIG. 8, the representation of each stock as a three-dimensional object at the origin of its own spatial co-ordinate system allows financial measures associated with the stocks and relative to the overall market to be easily compared, even by non-expert users. Moreover, the use of colour to represent a stock's risk allows the user to quickly identify the risk of each stock relative to the market, and to compare the risks of displayed stocks. As with displays of single stocks, particular financial data values for a stock displayed in the View All Shares Panel 802 can be viewed by moving the mouse pointer 1602 over the corresponding axis or object. For example, a beta value of 0.57 for a particular stock is displayed in a pop-up window 806 when the mouse pointer 1602 is moved over the object 808 corresponding to that stock. The user can also find stocks similar to a selected stock using a Find Similar Shares button 810, as described below.

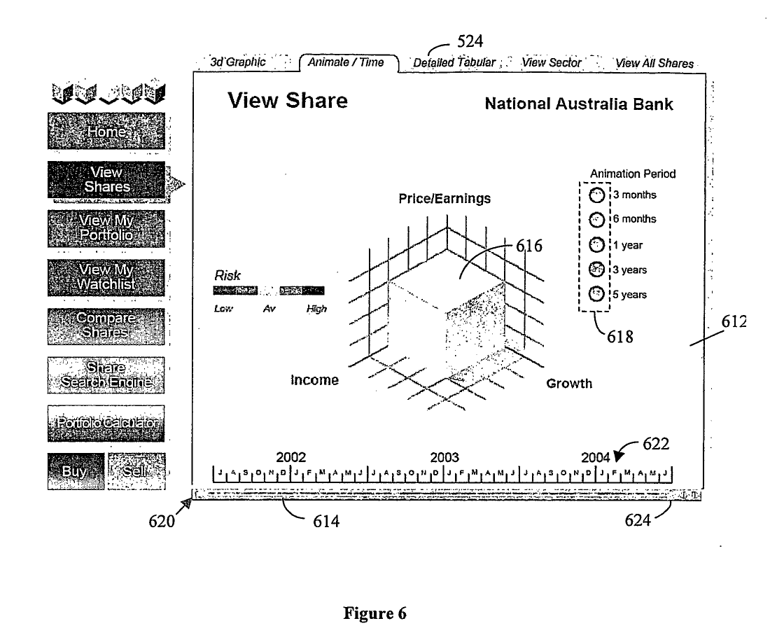

Returning to FIG. 5, historical data for the displayed financial data measures can be further visualised by selecting an animation tab 522 above the View Share panel 500. This results in the display of a Share Animation panel 612, as shown in FIG. 6. The panel 612 includes an animation control bar 614 that allows the user to control animation of the displayed object 616. A set of radio buttons 618 allows the user to select the time period for the historical share data animation, from periods of three months, six months, one year, three years, or five years. When the user selects a Play button 620 of the animation control bar 614, the displayed object 616 is animated so that its dimensions and colour dynamically change to represent the changing values of the corresponding financial measures over the period of time selected by the user. A time scale 622 displayed just above the animation control bar 614 allows the user to identify the corresponding points in time during the animation by following the passage of a slider control 624 from the left to the right of the animation control bar 614 as the animation progresses. The slider 624 can alternatively be manually dragged to any desired location on the animation control bar 614 to view historical stock data at any desired point in time within the selected animation period, or to restrict the animation to a sub-period within that period.

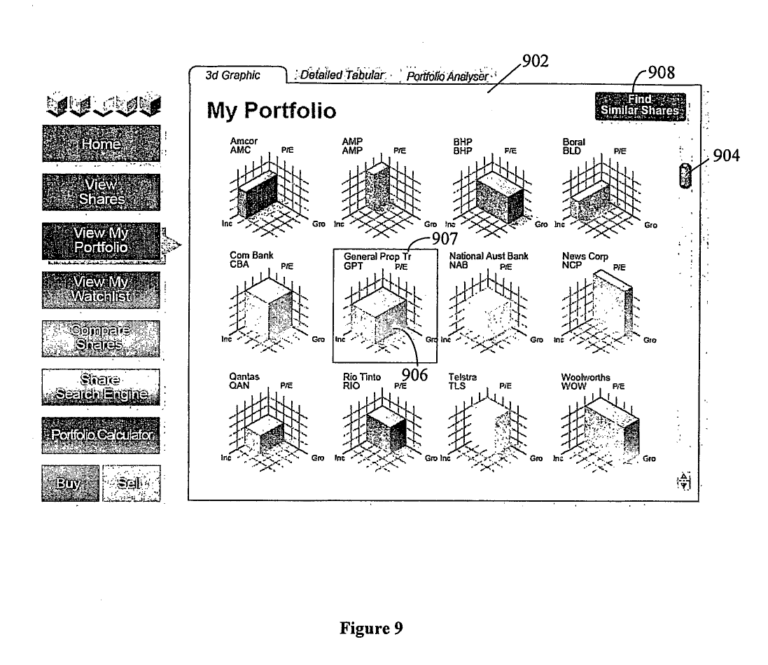

The imaging system allows the user to define a stock portfolio, and the user's portfolio can be displayed by selecting a View My Portfolio button 406. When this button 406 is selected, a View My Portfolio panel 902 is displayed, as shown in FIG. 9. The user's portfolio is displayed in groups of twelve shares, and a slider control 904 is provided in a scrollbar at the right-hand side of the View My Portfolio panel 902 to allow the user to scroll up and down to display their entire portfolio. This allows the user to easily view and comprehend the current status of their entire portfolio without needing to study detailed tables of numbers or graphical representations, which can be confusing, particularly for non-expert users.

As described above, the database 112 stores financial data for all stocks. Either continuously, or at periodic intervals, the transaction engine 106 retrieves stock market data from the stock exchange system 116 via the Internet 118. The retrieved data is then stored in the SQL database 112 by the transaction engine 106 to ensure that the database 112 is always up to date. The visualisation scripts 104 include AUTO-REFRESH elements so that the View My Portfolio panel 902 is periodically updated to reflect changes in the market. This allows the user to manage their portfolio in real-time.

The transaction engine 106 can retrieve real-time, delayed, historical, or forecast financial data from a variety of sources, including the companies themselves (in the case of stocks; e.g., earnings data), stock markets and exchanges, research and/or analyst and/or broking establishments, other financial institutions, find managers, media and other news outlets, owners of the web servers or broadcasters or other third parties.

In the preferred embodiment, the display data generated by the visualisation scripts 104 is provided in an image format, such as the portable network graphics (PNG) format or as scalable vector graphics (SVG), as described at http://www.w3.org/TR/SVG. In an alternative embodiment, the client system 114 includes a module that generates image display data from image description data sent to the client system 114 from the imaging system. For example, the image description data can indicate that a particular object is to be drawn in a particular colour and with particular axis values, and provides the financial values to be displayed in pop-up windows, as described above. The module may be a web browser plug-in module such as a Java applet, as described at http://java.sun.com/applet.

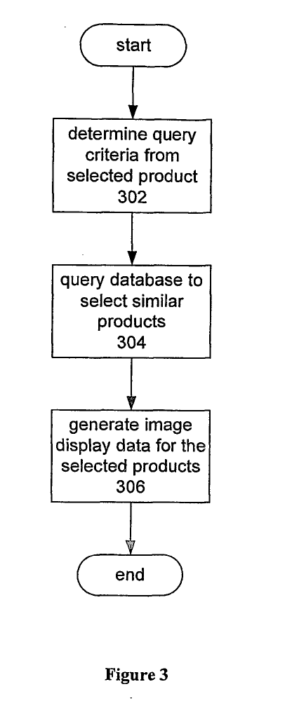

Individual shares in the user's portfolio can be selected, as indicated by the selected object 906 surrounded by a selection box 907. A Find Similar Shares button 908 allows the user to identify other stocks with characteristics similar to those of the selected stock. The imaging system selects financial products similar to a selected financial product by executing a financial product selection process, as shown in FIG. 3. The process begins at step 302 by determining database query criteria from the selected financial product. This involves identifying the four parameters represented by the selected object 906 for the selected financial product, and constructing a database query for financial products having similar values. The requirement of similarity can be adjusted as required, but by default is satisfied if a value is within 10% of the corresponding value for the selected financial product. At step 304, the database 112 is queried to select any financial products whose parameter measures are similar to those of the selected financial product. At step 306, display data for the selected financial products is generated from the data retrieved at step 304, and this is then returned for display to the user.

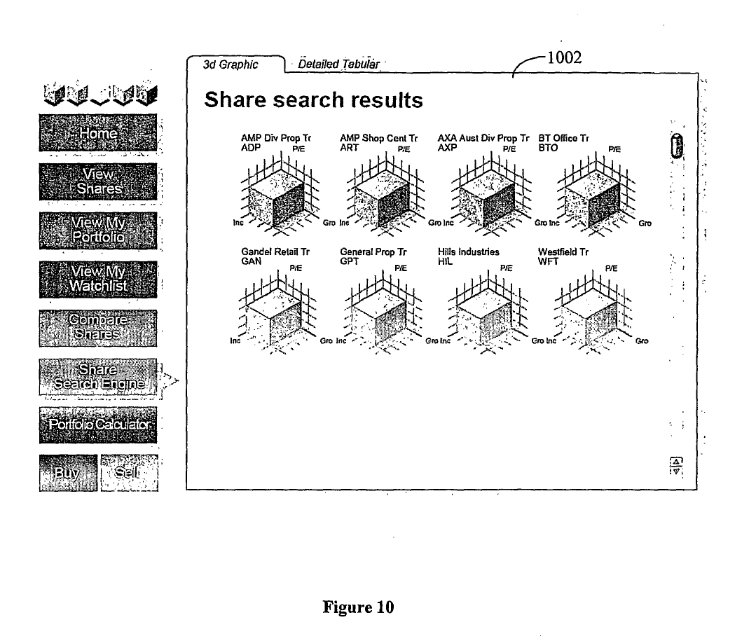

For example, in the case of the stock represented by the selected object 906 indicated by the selection box 907, selection of the Find Similar Shares button 908 results in the display of a Share Search Results panel 1002, as shown in FIG. 10. It will be apparent that the eight displayed objects are similar in size, shape and colour to the selected object 906 shown in FIG. 9. Thus the financial measures representing price to earnings ratio, income, growth, and risk of the stocks represented by the objects in FIG. 10 are all similar to those of the stock represented by the selected object 906 shown in FIG. 9. The ability to rapidly and easily select stocks similar to a selected stock can be useful in managing a stock portfolio. For example, a stock of the user's portfolio that has been performing particularly well can be used to identify similar stocks in the overall market, and the user may wish to invest in these identified stocks. Conversely, the user can easily identify stocks similar to a stock performing particularly poorly.

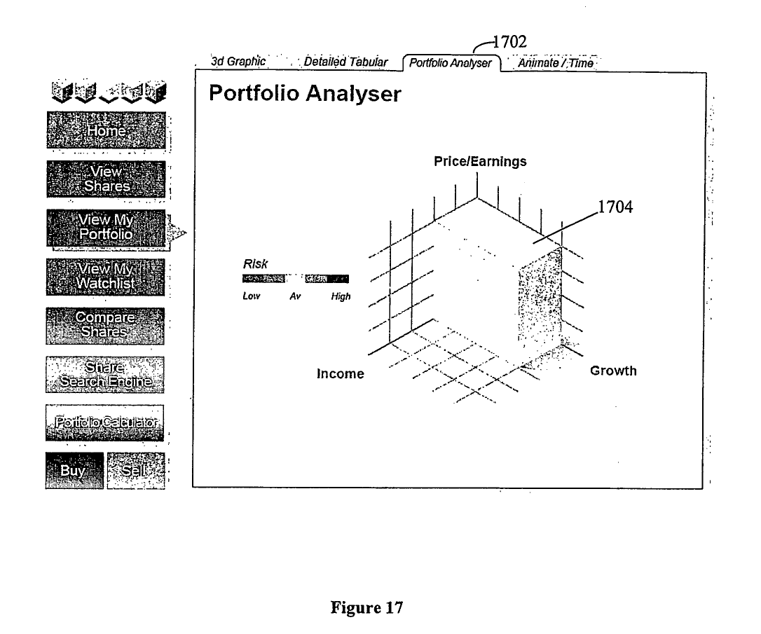

The user's stock portfolio can alternatively be represented as an aggregate. As shown in FIG. 17, selection of a portfolio analyser tab 1702 results in the display of a three-dimensional aggregate object 1704 representing the aggregate of the user's stock portfolio, weighted by the price and volume of each stock owned by the user. Thus as the market changes, or when the user trades stocks, the impact of any changes on the user's total portfolio can be readily visualised and evaluated.

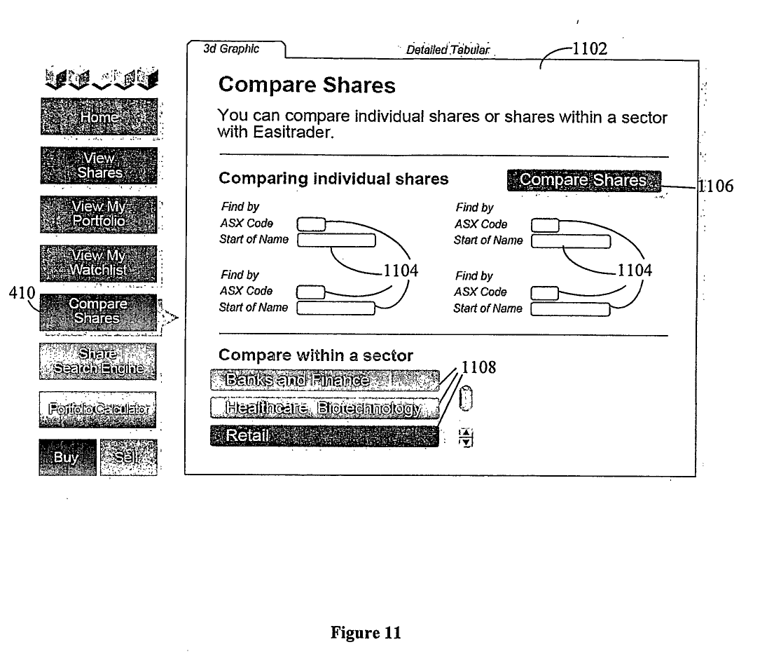

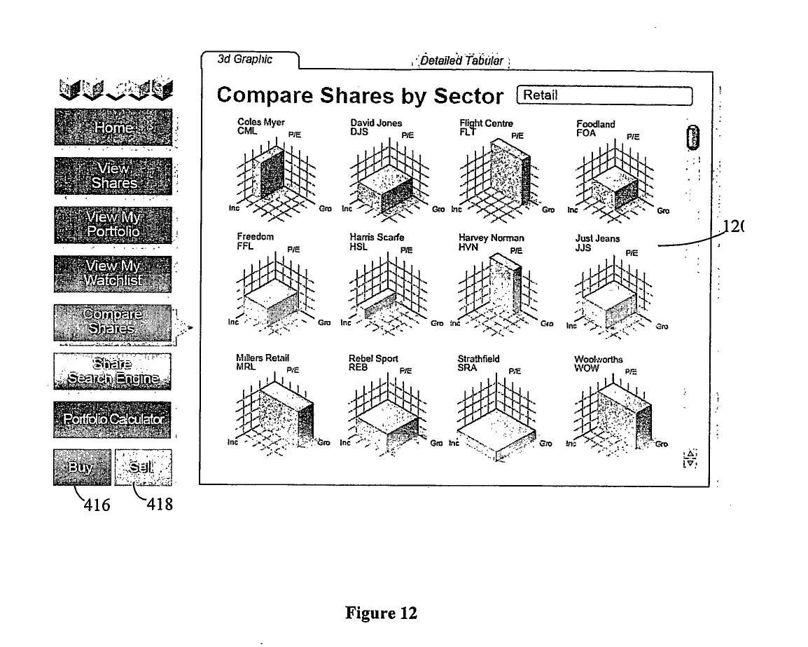

As shown in FIG. 11, individual stocks can be compared using a Compare Shares panel 1102, displayed by selecting a Compare Shares button 410. Information identifying up to four stocks can be entered into text boxes 1104, and a Share Comparison button 1106 selected to generate a display of objects representing those stocks. Alternatively, stocks can be compared within a particular sector of the market by selecting one of the Sector Selection buttons 1108. For example, shares within the Retail Sector can be compared, as shown by the Compare Shares by Sector panel 1202 of FIG. 12. Thus a user wishing to invest in a particular sector can browse the displayed objects representing stocks within that sector in order to identify those most attractive for investment purposes. Once a particular stock has been identified, the user can invest in that stock by selecting the corresponding displayed object and then selecting a Buy button 416. A stock transaction is then initiated by the transaction engine 106 communicating with the remote stock exchange system 116 to perform the actual stock buy transaction after the user specifies transaction data such as the number of shares to be purchased and the price per share. Conversely, the user can sell shares from their portfolio by selecting a Sell button 418.

As shown in FIG. 5, a View Sector tab 526 can be selected when viewing a selected stock to display the stock together with other stocks in the same category, sector or industry group, or another grouping of stocks, as selected by the user.

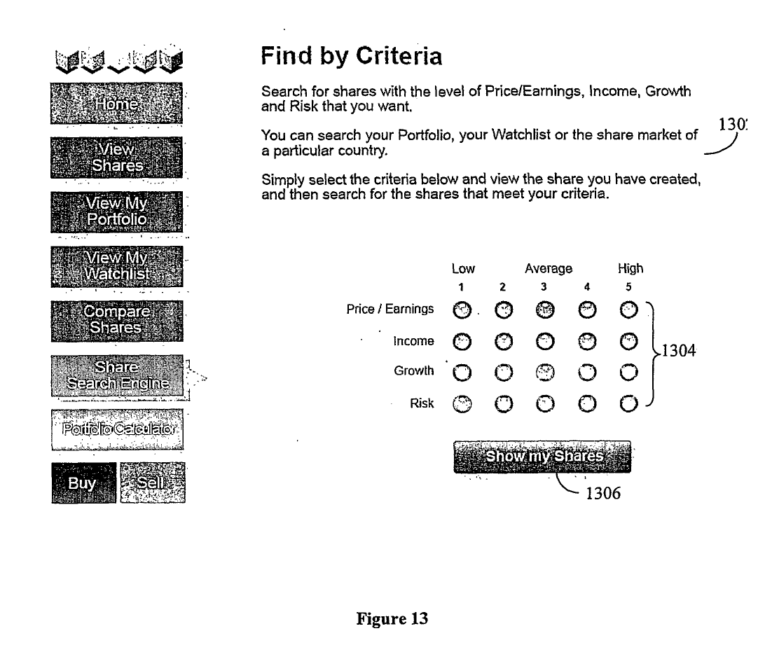

Stocks matching user-specified criteria can also be found by entering display criteria into a Find by Criteria panel 1302, as shown in FIG. 13. The Find by Criteria panel 1302 provides find criteria radio buttons 1304, allowing the user to select relative values for the displayed measures, in this case being price to earnings ratio (PIE), income, growth, and risk, on a relative scale of 1 to 5 for each measure. After the desired values have been selected, a Show my Shares button 1306 is selected to identify stocks whose financial measures match the selected criteria by searching the database 112.

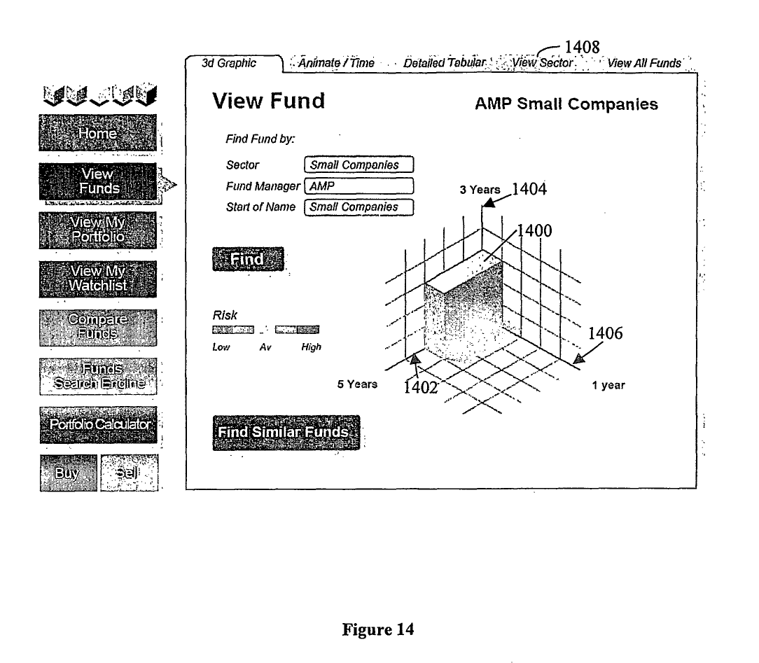

The imaging system can also be used to display financial data for mutual funds. The imaging system provides information about the return and risk of individual funds relative to funds in the same sector or other grouping of funds, as selected by the user. As described above in the context of stocks, funds can be compared, and funds with similar characteristics can be identified. Changes with funds over time can also be displayed as tabular data, in graph form, or as an animated object, as described above. However, in contrast to the default financial measures used to represent shares, the imaging system represents each fund by an object whose dimensions represent the return of the fund over time relative to funds in the same sector, assuming all distributions have been reinvested. As shown in FIG. 14, the left hand horizontal axis 1402 indicates fund return over the previous five years; the vertical axis 1404 corresponds to the fund's return over the previous three years, and the right hand horizontal axis 1406 represents the return of the fund over the previous 12 months. The colour of the object 1400 represents the relative risk of the returns of a fund, the default measure of risk being the volatility of the fund's return relative to the average return of all funds in the same sector (or other groupings of funds, as selected by the user). Funds with a relatively high volatility have had more volatile returns over the previous 12 months, and funds with a low volatility have had less volatile returns over this period. Alternatively, the user can select other measures of risk to determine the object's colour, such as a measure of the diversification of the fund, for example. A View fund/sector tab 1408 displays the selected fund together with other funds in the same fund category or sector.

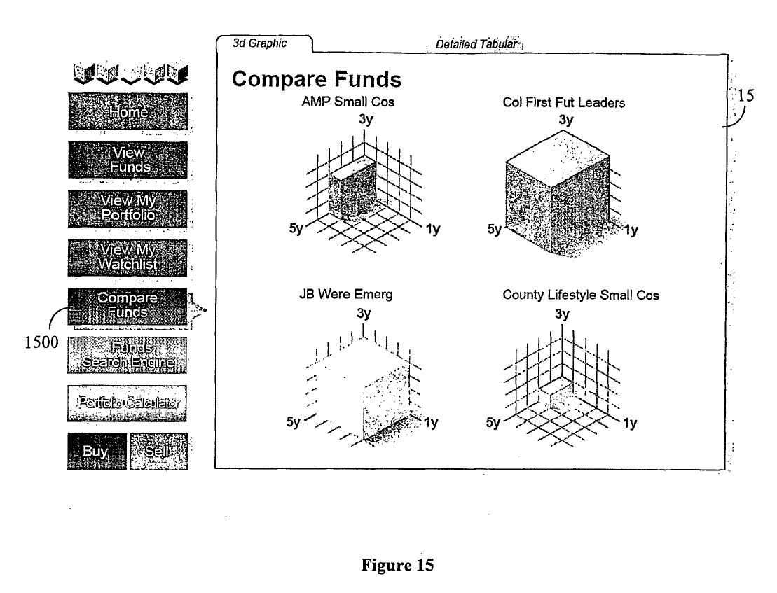

As shown in FIG. 15, selection of a Compare Funds button 1500 causes the imaging system to display a Compare Funds panel 1502 that allows the user to easily compare the performance of funds by a simple visual comparison of the objects representing those funds. The differing returns of these funds over the past 1, 3, and 5 years is readily apparent from the different respective dimensions of the displayed objects representing the funds, and the relative risk of each fund is apparent from the colour of the corresponding object.

Returning to FIG. 4, a View My Watchlist button 408 is provided to allow the user to display and monitor the performance of financial products of interest which may or may not be owned by the user. The user can define multiple watchlists of stocks and/or funds.

Although the imaging system has been described in relation to stocks and mutual and other managed funds, it will be apparent that the imaging process and system can be applied to visualise other types of financial data. This includes financial data for financial products such as derivatives, bonds and other financial instruments and/or assets, superannuation and other retirement plans, options and futures, portfolios and other aggregates, real estate, insurance, loans, leases, mortgages and other lending methods and instruments, financial, personal, business and other commercial accounts and balances, credit cards and other financial and/or commercial accounts and transactions.

The ability of the imaging system to generate simple object images representing financial data for a number of financial products in a manner that is easy for non-expert or lay users to comprehend allows such users to compare and evaluate those products. The imaging system thus constitutes a powerful tool for making decisions in relation to financial products.

In addition to the uses described above, the imaging system can also be used as an evaluation tool on a financial information portal web site such as those at http://moneycentral.msn.com and http://www.morningstar.com. In such cases, the imaging system is used to undertake research and make judgements about stocks, with the actual stock transactions performed by another tool, site, or party. In an alternative embodiment, the imaging system can access a remote transaction or trading system such as www.etrade.com rather than a stock exchange system to retrieve current financial data and/or to perform financial transactions such as buy and sell operations. The imaging system is also valuable as an educational tool.

Many modifications will be apparent to those skilled in the art without departing from the scope of the present invention as herein described with reference to the accompanying drawings.

1. An imaging process, including generating image display data representing a three-dimensional object at the origin of a spatial coordinate system, the three dimensions of said object representing respective financial data for a financial product.

2. An imaging process as claimed in claim 1, wherein said object is represented isometrically by said image display data.

3. An imaging process as claimed in claim 1, wherein said object is a cuboid or rectangular parallelepiped.

4. An imaging process as claimed in claim 1, wherein the three dimensions of said object represent respective parameters of said financial data.

5. An imaging process as claimed in claim 4, wherein said parameters are selected by a user.

6. An imaging process as claimed in claim 4, including generating control data for generating user interface components to allow a user to select one or more of said financial product and said parameters of financial data for said product.

7. An imaging process as claimed in claim 4, including generating at least one of said parameters from said financial data.

8. An imaging process as claimed in claim 1, wherein the color of said object represents financial data for said product.

9. An imaging process as claimed in claim 8, wherein the color of said object represents a parameter of said financial data.

10. An imaging process as claimed in claim 1, wherein the color of said object represents a measure of risk for said financial product.

11. An imaging process as claimed in claim 4, wherein said parameters of said financial data for said financial product are normalized with respect to respective parameters of financial data for a plurality of financial products.

12. An imaging process as claimed in claim 11, wherein said parameters of said financial data for said financial product are normalized with respect to respective parameters of financial data for the overall market for said financial product.

13. An imaging process as claimed in claim 4, wherein the parameters of said financial data for said financial product are quantized.

14. An imaging process as claimed in claim 1, wherein the dimensions of said object are quantized.

15. An imaging process as claimed in claim 1, including generating display data for displaying a financial data value for said financial product in response to movement of a pointing device over a corresponding portion of an image generated from said image display data.

16. An imaging process as claimed in claim 1, including regenerating said image display data to reflect changes in said financial data.

17. An imaging process as claimed in claim 1, wherein said image display data includes image animation data for generating an animated representation of said object representing changes of said financial data over time.

18. An imaging process as claimed in claim 1, wherein said financial product includes a stock.

19. An imaging process as claimed in claim 18, wherein the three dimensions of said object respectively represent one or more of price, income, growth, return on assets, debt to equity ratio, and volume of trading of said stock.

20. An imaging process as claimed in claim 18, wherein the three dimensions of said object represent respective measures of price, income, and growth of said stock.

21. An imaging process as claimed in claim 20, wherein said measures include price to earnings ratio, dividend yield, and growth in earnings per share.

22. An imaging process as claimed in claim 21, wherein said measures are normalized with respect to respective measures for a plurality of stocks.

23. An imaging process as claimed in claim 18, wherein the color of said object represents a risk measure for said stock.

24. An imaging process as claimed in claim 23, wherein said risk measure includes a beta value for said stock.

25. An imaging process as claimed in claim 1, wherein said financial product represents an aggregate of funds.

26. An imaging process as claimed in claim 1, wherein said financial product represents an aggregate of stocks.

27. An imaging process as claimed in claim 1, wherein said financial product represents an aggregate of funds and stocks.

28. An imaging process as claimed in claim 1, wherein said financial product includes a managed fund or a mutual fund.

29. An imaging process as claimed in claim 28, wherein said dimensions represent respective measures for said fund.

30. An imaging process as claimed in claim 29, wherein said measures include one or more of financial return, rolling return, entry fee, management expense ratio, and independent rating.

31. An imaging process as claimed in claim 28, wherein said dimensions represent measures of financial return over respective periods of time for said fund.

32. An imaging process as claimed in claim 31, wherein said periods are selected by a user.

33. An imaging process as claimed in claim 31, wherein said periods correspond to 1, 3, and 5 year periods.

34. An imaging process as claimed in claim 31, wherein the color of said object represents a risk measure for said fund.

35. An imaging process as claimed in claim 34, wherein said risk measure represents the volatility of said fund.

36. An imaging process as claimed in claim 33, wherein said measures are normalized with respect to a plurality of funds.

37. An imaging process as claimed in claim 1, including generating image display data representing two or more objects for respective financial products to enable comparison of said financial products, wherein the color of each object represents financial data for the corresponding financial product.

38. An imaging process as claimed in claim 1, including generating image display data representing two or more objects for respective financial products to enable comparison of said financial products, wherein the three dimensions of each object represent respective financial data for the corresponding financial product.

39. An imaging process as claimed in claim 38, wherein the color of each object represents financial data for the corresponding financial product.

40. An imaging process as claimed in claim 38, wherein said image display data represents said two or more objects at the origin of a spatial coordinate system.

41. An imaging process as claimed in claim 38, wherein said image display data represents said two or more objects at the origins of respective spatial coordinate systems.

42. An imaging process as claimed in claim 38, wherein said financial products include stocks.

43. An imaging process as claimed in claim 38, wherein said financial products include managed funds or mutual funds.

44. An imaging process as claimed in claim 1, including receiving transaction data in respect of a financial product from a user, and initiating a financial transaction on the basis of said transaction data.

45. An imaging process as claimed in claim 44, wherein said initiating includes initiating a financial transaction with a remote transaction system.

46. An imaging process as claimed in claim 1, including selecting at least one financial product on the basis of a comparison of financial data for said at least one financial product with predetermined financial data.

47. An imaging process as claimed in claim 46, wherein said predetermined financial data is specified by a user.

48. An imaging process as claimed in claim 46, including selecting at least one financial product corresponding to a selected financial product category.

49. An imaging process as claimed in claim 1, including selecting at least one financial product on the basis of a comparison of financial data for said at least one financial product with corresponding financial data for another selected financial product.

50. An imaging process as claimed in claim 49, wherein each said at least one financial product is selected if the dimensions of an object represented by image display data for said at least one financial product are similar to those of the selected financial product.

51. An imaging process as claimed in claim 49, wherein each said at least one financial product is selected if the color of an object represented by image display data for said at least one financial product is similar to that of the selected financial product.

52. An imaging process as claimed in claim 49, wherein said selecting includes selecting at least one financial product if the financial data for said at least one financial product is similar to corresponding displayed financial data for another selected financial product.

53. An imaging process as claimed in claim 52, wherein financial data for two or more financial products is similar if differences between the respective financial data are within a predetermined value.

54. An imaging process as claimed in claim 1, including generating a display of said image display data.

55. An imaging process, including generating image display data representing a three-dimensional object, the three dimensions and the color of said object representing respective financial data for a financial product.

56. An imaging process, including generating image display data representing a three-dimensional object, the three dimensions of said object representing respective measures of price, income, and growth of a stock.

57. An imaging process as claimed in claim 56, wherein the color of said object represents a risk measure for said stock.

58. An imaging process as claimed in claim 57, wherein said risk measure includes a beta value for said stock.

59. An imaging process, including generating image display data representing a three-dimensional object, the three dimensions of said object representing performance data for a fund over respective time periods.

60. An imaging process as claimed in claim 59, wherein said periods are periods of one, three, and five years.

61. An imaging process as claimed in claim 59, wherein the color of said object represents a risk measure for said fund.

62. An imaging process as claimed in claim 61, wherein said risk measure includes a measure of volatility of said fund.

63. An imaging process, including generating image display data representing a three-dimensional object at the origin of a spatial coordinate system, the three dimensions and color of said object representing respective financial data for a financial product.

64. An imaging process as claimed in claim 63, wherein said financial data is normalized with respect to other financial products.

65. An imaging process as claimed in claim 64, wherein the color of said object represents a measure of risk for said financial product.

66. An imaging process as claimed in claim 65, wherein said financial product includes a stock, the dimensions of said object representing price to earnings ratio, dividend yield, and growth in earnings per share for said stock.

67. An imaging process as claimed in claim 65, wherein said financial product includes a managed fund or a mutual fund, the dimensions of said object representing measures of financial return over respective periods of time for said fund.

68. An image data process, executed by a computing device, including generating image display data for displaying a three-dimensional object at the origin of a spatial coordinate system, the three dimensions of said object representing respective financial data for a financial product.

69. An image data process as claimed in claim 68, including sending said image display data to a display device for display to a user.

70. An image data process as claimed in claim 68, including generating a display of said object representing said image display data.

71. A system having components for executing the steps of claim 1.

72. A computer readable storage medium having stored thereon program code for executing the steps of claim 1.

73. Image display data generated by executing the steps of claim 1.

74. A graphical user interface including image display data generated by executing the steps of claim 1.

75. An imaging system, including a visualisation module for generating image display data representing at least one three-dimensional object at the origin of a spatial coordinate system, the three dimensions of each object representing respective financial data for a corresponding financial product.

76. An imaging system as claimed in claim 75, wherein the system is adapted to receive said financial data from a remote system to enable said visualisation module to update said image display data.

77. An imaging system as claimed in claim 76, including a server for receiving a request for said image display data and for sending said image display data in response to said request.

78. An imaging system as claimed in claim 76, including a transaction module for initiating a financial transaction on the basis of received transaction data in respect of a financial product.

79. An imaging system as claimed in claim 75, wherein the financial data for each financial product is normalized with respect to other financial products.

80. An imaging system as claimed in claim 75, wherein the color of each object represents financial data for the corresponding financial product.

81. An imaging system as claimed in claim 80, wherein the color of each object represents a measure of risk for the corresponding financial product.

82. An imaging system as claimed in claim 75, wherein each financial product includes a stock, and the three dimensions of each object respectively represent price to earnings ratio, dividend yield, and growth in earnings per share for the corresponding stock.

83. An imaging system as claimed in claim 75, wherein each financial product includes a managed fund or a mutual fund, and the three dimensions of each object represent measures of financial return over respective periods of time for the corresponding fund.

84. A graphical user interface, including a display of a three-dimensional object at the origin of a spatial coordinate system, the three dimensions of said object representing respective financial data for a financial product.

85. A graphical user interface as claimed in claim 84, the color of said object representing financial data for said financial product.

86. A graphical user interface as claimed in claim 85, the color of said object representing a risk measure for said financial product.

87. A graphical user interface as claimed in claim 84, wherein said financial product includes a stock, the three dimensions of each object respectively representing price to earnings ratio, dividend yield, and growth in earnings per share for said stock.

88. A graphical user interface as claimed in claim 84, wherein said financial product includes a managed fund or a mutual fund, the three dimensions of each object representing measures of financial return over respective periods of time for said fund.

89. A computer program, stored on computer readable media, for generating image display data representing a three-dimensional object at the origin of a spatial coordinate system, the three dimensions of said object representing respective financial data for a financial product.

90. Image display data, including image coordinate data representing a three-dimensional object at the origin of a spatial coordinate system, the three dimensions of said object representing respective financial data for a financial product.

91. Image display data as claimed in claim 90, including color data representing color of said object, said color representing financial data for said financial product.

92. An imaging process as claimed in claim 8, wherein the financial data represented by said color is normalized with respect to a plurality of financial products.

93. An imaging process as claimed in claim 8, wherein the financial data represented by said color is normalized with respect to an overall market for said financial product.

94. An imaging process as claimed in claim 23 wherein said risk measure for said stock is normalized with respect to a plurality of stocks.
